(19) United States
(12) Patent Application Publication
(10) Pub. No.: US 2016/0332899 A1
(43) Pub. Date: Nov. 17, 2016

(54) WASTE WATER TREATMENT DEVICE

(71) Applicant: WATER MAX NANJING ENVIRONMENT TECHNOLOGY CO., LTD., La Prairie (CA)

(72) Inventor: Benson HAN, La Prairie (CA)

(21) Appl. No.: 15/046,268

(22) Filed: Feb. 17, 2016

(30) Foreign Application Priority Data
May 13, 2015 (CN) 201520305353.2

(51) Int. Cl. C02F 1/52; C02F 1/42; C02F 1/00; C02F 1/66

(52) U.S. Cl. CPC C02F 1/5281; C02F 1/66; C02F 1/42; C02F 1/001; C02F 2201/005

(57) ABSTRACT

There is described an embodiment of a wastewater treatment system comprising a plurality of agitating devices and dosing devices. The agitating devices connect with a tank though a water pipe. The agitation devices are connected through connecting pipes. The treated wastewater is discharged by a blow-off pipe. The dosing devices are installed on the water pipe and the connecting pipes. The dosing devices doses at least one of: a flocculants, a coagulant, a pH adjuster and combination thereof. This embodiment of a wastewater treatment system allows for ion exchange between wastewater and flocculants by using high-speed rotating blades of a pump. Treatment of wastewater is performed with small-sized equipment with high efficiency.

### BACKGROUND

(a) Field

The subject matter disclosed generally relates to wastewater treatment. More specifically, it relates to systems for rapid treatment of wastewater.

(b) Related Prior Art

Industrial wastewater treatment facilities typically rely on flocculating. Flocculants are added to the wastewater tank in which an agitating device is provided. The agitating device normally performs stirring at a speed of 40 rpm. Moreover, the agitating device is bulky and requires high power to operate. Although effective, this method is time-consuming; at least 30 minutes are necessary to complete the ion exchange between wastewater and the flocculants. Flocculating further requires that the tank be a large container or a pool, which is expensive and requires a large area. This type of wastewater treatment is characterized by a high cost and a low efficiency.

### SUMMARY

The present invention addresses the technical drawbacks mentioned above. There is provided an embodiment of a rapid wastewater treatment system, in which the ion exchange between wastewater and the flocculants is occurring. Wastewater is treated with small-sized equipment and with high efficiency.

In order to address the aforementioned technical drawbacks, there is provided a rapid wastewater treatment system comprising a plurality of agitating devices and dosing devices. The agitating devices communicate with the tank through a water pipe and communicate therebetween through connecting pipes. Treated water is discharged by an outlet or blow-off pipe. The dosing devices are installed on the water pipe or on connecting pipes.

According to an embodiment, the agitating device is a water pump or an agitated tank (i.e., stirred tank). The water pipe or connecting pipes are threaded pipes to provide a vortex effect to the water flowing therein. The water pipe or connecting pipes comprise flow-slowing devices with top and bottom spoilers having a plurality of holes on the surface thereof. A plurality of spring groups are provided between the top and bottom spoilers, and the bottom spoiler is located far away from the tank, inside the water or the connecting pipe. The connecting pipes have a sigmoid, spiral or rectangular bending shape. The dosing device is a pump or a siphon valve; the flocculants is sucked into the connecting pipe through the dosing pump or siphon.

According to an embodiment, the pump is a centrifugal pump, homogeneity pump, spiral pump, or a gear pump or a combination thereof. A water pipe is provided at one end of the tank and is equipped with a filter cap. The blow-off pipe is connected to the filter unit, which is connected to a pressure filter. The dosing device doses the flocculants to be poured. The filter unit is a hop-pocket filter. There is provided a network-connected sensor on the blow-off pipe of the pressure filter to monitor the outlet.

In the treatment system, wastewater and flocculants are mixed together using pumps with at least one high-speed rotating blade therein, or using at least one agitated tank being stirred, thereby performing ion exchange quickly. Small particle of matter and metal ions coagulate into the floccule. The treatment system then separates the treated water from the floccule by various types of filtering means, thereby treating the wastewater into treated water quickly. Although it is small in size, the treatment system is highly efficient. Connecting pipes between pumps and tanks are given a sigmoid, spiral or rectangular bending shape. A flow slowing device is provided inside the connecting pipes to increase the time during which ion exchange between wastewater and flocculants takes place. This further improves the efficiency of wastewater treatment.

This wastewater treatment system takes advantage of the properties of flocculants. It provides high speed and turbulence, thanks to the high speed rotating blades inside the pump. Flocculants are then pumped into the pump to mix the wastewater and flocculants together quickly. This way, complete ion exchange occurs between small particle of matter and the flocculants, thereby separating the wastewater into treated water on one hand, and heavy metals, organic matter, etc., on the other hand. This process can treat wastewater in a second. Furthermore, the equipment has a small size and, therefore, does not require a large area, which is financially advantageous. This process can treat wastewater dozens of times more quickly than existing processes discussed above by performing complete flocculating more quickly, thanks to the process described herein using flocculants to treat wastewater.

This wastewater treatment system is advantageous in that the embodiment of rapid wastewater treatment system described herein makes ion exchange occurs between wastewater and the flocculants by operating a pump with high-speed rotating blades, thereby treating wastewater with small-sized and highly-efficient equipment. Connecting pipes between pumps and tanks are given a sigmoid, spiral or rectangular bending shape. A flow slowing device is provided inside the connecting pipes to increase the time during which ion exchange between wastewater and flocculants takes place. This further improves the efficiency of wastewater treatment.

According to an aspect of the invention, there is provided a wastewater treatment system comprising a tank, a plurality of agitating devices, dosing devices and a blow-off pipe, the agitating devices connecting with the tank through a water pipe, the plurality of agitating devices being connected therebetween by connecting pipes, the dosing devices being provided on the water pipe and the connecting pipes, the blow-off pipe being for discharging treated wastewater; wherein the dosing devices doses at least one of: a flocculants, a coagulant, a pH adjuster and combination thereof, wherein the flocculants and coagulant are instant dissolving.

According to an embodiment, each one of the agitating devices comprise one of a pump and an agitated tank.

According to an embodiment, at least one of the water pipe and the connecting pipes comprise a threaded pipe.

According to an embodiment, the connecting pipes have at least one of: a sigmoid shape, a spiral shape, and a rectangular bending shape.

According to an embodiment, at least one of the water pipe and the connecting pipes comprise a flow-slowing device therein.

According to an embodiment, the flow-slowing device comprises top and bottom spoilers, the spoilers comprising holes on a surface thereof, a plurality of spring groups being provided, each one between a top spoiler and a bottom spoiler, wherein a most distant one of the bottom spoilers is installed inside one of: the water pipe and one of the connecting pipes.

According to an embodiment, each one of the dosing devices comprises one of a dosing pump and a siphon valve, wherein the pump, the valve or both are anti-negative pressure.

According to an embodiment, each one of the agitating device is a pump, each pump being one of: a centrifugal pump, a homogeneity pump, a spiral pump and a gear pump.

According to an embodiment, the water pipe is installed at one end of the tank and comprises a filter cap, the blow-off pipe being connected to a filter unit which is connected to a pressure filter.

According to another embodiment, the dosing device doses a flocculants, a coagulant and a pH adjuster.

As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a schematic diagram of a wastewater treatment system, according to an embodiment.

It will be noted that throughout the appended drawings, like features are identified by like reference numerals.

### DETAILED DESCRIPTION

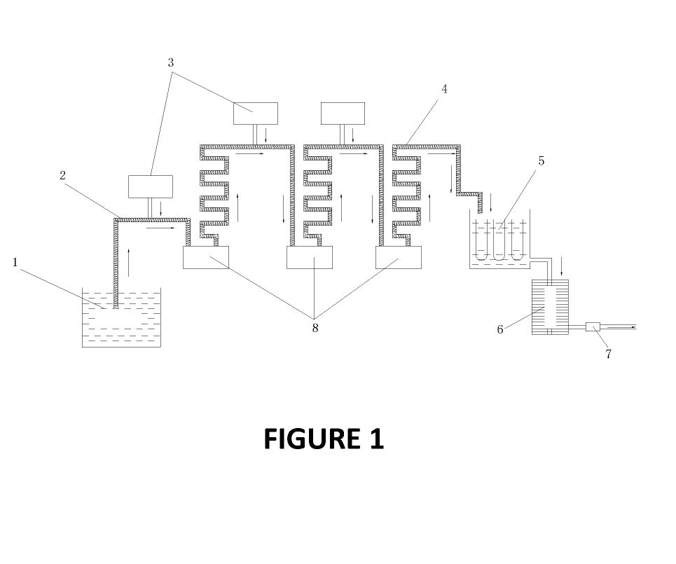

FIG. 1 shows an embodiment of a rapid wastewater treatment system comprising a plurality of agitation devices and dosing devices 3. According to the embodiment shown in FIG. 1, the agitation devices comprise a water pump 8. The water pump 8 connects with the wastewater tank 1 through a water pipe 2. Neighboring water pumps 8 are connected therebetween through connecting pipes 4. Treated wastewater is discharged into a filtering device 5 which is connected to a pressure filter 6. Each dosing device 3 is connected with the water pipe 2 or one of the connecting pipes 4 according to its location.

The water pipe 2 and connecting pipes 4 can be threaded pipes, or other types of pipes having a water-contacting surface providing a vortex effect to the flowing water. A plurality of groups of flow-slowing devices is provided inside water pipe 2 or connecting pipes 4. There is provided at least one group of flow-slowing devices between each one of the dosing devices and the next water pump 8. The flow-slowing devices comprise top and bottom spoilers in order to improve ion exchange between the flocculants and wastewater. A plurality of springs is provided between the top and bottom spoilers. The down spoiler which is the most distant from the wastewater tank 1 is installed inside the water pipe 2 or in a connecting pipe 4.

There are usually provided between one and ten water pumps 8, or even more. Each one of the water pumps 8 can be a centrifugal pump, a homogeneity pump or a spiral pump, or any other type of pump. There is no restriction on pump type, specification, pressure, voltage, revolving speed, flow, etc., as long as they satisfy the need for a specific context with regard to these properties. The pumps are connected therebetween by connecting pipes having a sigmoid or rectangular bending shape. A dosing device is installed in these pipes before each one of the pumps 8 or inside the pumps 8. The dosing device has a blow-off pipe that directly connects to the connecting pipe or to the center of the pump. Precise location, size and materials can be chosen depending on the needs for a specific context. The connecting pipes 4 between pumps 8 also can be made with all kinds of materials, such as copper pipe, metal pipe, plastic pipe, stainless steel pipe and so on. The connecting pipe 4 is made with pipes in sigmoid or rectangular bending shape. The water pipe 2 is on one end of the wastewater tank 1 and is equipped with filter cap. The active ingredient that is put into dosing devise 3 is a flocculants. The described filtering unit 5 is a bag filter. There is provided a network-connected sensor on the blow-off pipe of the pressure filter to monitor the outlet.

According to an embodiment, the wastewater flow first passes through a filtering cap that filters different sizes to prevent rigid particles to be brought into the pump 8 and damage the pump. The flow is then pumped directly into the first pump 8 through water pipe 2. Flocculants are pumped into the center of the pump or into one of the S-shaped connecting pipes 4 before the wastewater reaches the pump. Depending on the properties of the wastewater, other pumps 8 and connecting pipes 4 are provided. Additional flocculants are pumped into the center of these additional pumps or S-shaped connecting pipes 4. The high-speed pumps 8 which may include a high speed mixer, achieve ion exchange between wastewater and flocculants. Downstream of the last pump 8, which is the last in which flocculating occurs, water is pumped to a filtering device to be filtered depending on the pressure of pump 8 itself. After having passed through different filters, the fine particles of matter in the wastewater coagulate with the flocculants and stay on the surface of filtering net or cloth, and the purified water is discharged continuously.

The wastewater treatment system can work continuously when the wastewater temperature is between 0 and 70 C. Handling capacity can be adapted according to the amount of wastewater that needs to be treated by adjusting the size of the hybrid pump 8 and connecting pipes 4. The wastewater treatment system occupies a very small area. The pumps 8 can also be synchronized; complete sets can be made in various form factors.

According to an embodiment, the pump 8 is a hybrid pump having a 5.5 kW motor as main engine. Each pump can mix and flocculate 54 m³ of wastewater per hour at high speed. In other words, a pump of 5.5 kw can continuously treat 400m³ of wastewater if working 8 hours and 1200 m³ of wastewater if working 24 hours per day. The capacity of water treatment can be increased by providing a pump 8 with stronger power, for example, to double the capacity of water treatment.

Smaller-scale wastewater treatment systems can be made by decreasing the power of the main engine of the hybrid pump 8. For example, a 750 W pump 8 can continuously treat 2,000 liters of wastewater per hour and at least 16,000 liters of wastewater per day. In contrast with prior processes, where 2.5 workers where needed to operate during 10 hours two 5,000-liter tanks for flocculating and sedimentation, the wastewater treatment system described herein only requires four or five hours of operation per day. In this example, the need in wastewater treatment is 10,000 liters per day; if the 750 W main engine of the pump 8 is changed for a 2,200 W motor, all wastewater can be treated in about 30 minutes to 1 hour with 0.5 worker.

The dosing devices 3 can dose flocculants, coagulants, pH adjusters, or a combination thereof. Flocculants can be chosen, without limitation, among ionic compounds such as: alum, aluminium chlorohydrate, aluminium sulphate, calcium oxide, calcium hydroxide, iron(II) sulphate (ferrous sulphate), iron(III) chloride (ferric chloride), polyacrylamide, or polyDADMAC, sodium aluminate, sodium silicate), or natural products such as: Chitosan, Isinglass, Moringa oleifera seeds (Horseradish Tree), gelatin, Strychnos potatorum seeds (Nirmali nut tree), guar gum, or Alginates (brown seaweed extracts). Coagulants can be chosen, without limitation, among inorganic coagulants (aluminum sulfate, aluminum chloride, polyaluminum chloride (PACI) & aluminum chlorohydrate (ACH), Ferric Sulfate and Ferrous Sulfate, Ferric Chloride), or organic coagulants (e.g., polyamine and polyDADMAC, melamine formaldehydes and tannins).

Most governments around the world are presently reforming and improving their environment protection policies. The wastewater treatment system described herein is line with these changes. Those who produce wastewater struggle to treat it while respecting environmental laws and requirements issued by the government. The lack of affordable and efficient wastewater treatment system was an issue for businesses, government and specialists. Usual solutions involve unorthodox methods to treat wastewater which are often inefficient, resulting in a poor quality of water discharged into the environment. The wastewater treatment system described herein addresses this issue and provides an affordable and efficient solution that can be implemented by businesses. If implemented in industrial facilities that presently discharge inefficiently-treated wastewater into the environment, it can improve freshwater quality, thereby improving the appearance of rivers and habitability for fish.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A wastewater treatment system comprising a tank, a plurality of agitating devices, dosing devices and a blow-off pipe, the agitating devices connecting with the tank through a water pipe, the plurality of agitating devices being connected therebetween by connecting pipes, the dosing devices being provided on the water pipe and the connecting pipes, the blow-off pipe being for discharging treated wastewater; wherein the dosing devices doses at least one of: a flocculants, a coagulant, a pH adjuster and combination thereof, wherein the flocculants and coagulant are instant dissolving.

2. The wastewater treatment system of claim 1, wherein each one of the agitating devices comprise one of a pump and an agitated tank.

3. The wastewater treatment system of claim 2, wherein at least one of the water pipe and the connecting pipes comprise a threaded pipe.

4. The wastewater treatment system of claim 3, wherein the connecting pipes have at least one of: a sigmoid shape, a spiral shape, and a rectangular bending shape.

5. The wastewater treatment system of claim 1, wherein at least one of the water pipe and the connecting pipes comprise a flow-slowing device therein.

6. The wastewater treatment system of claim 5, wherein the flow-slowing device comprises top and bottom spoilers, the spoilers comprising holes on a surface thereof, a plurality of spring groups being provided, each one between a top spoiler and a bottom spoiler, wherein a most distant one of the bottom spoilers is installed inside one of: the water pipe and one of the connecting pipes.

7. The wastewater treatment system of claim 1, wherein each one of the dosing devices comprises one of a dosing pump and a siphon valve, wherein the pump, the valve or both are anti-negative pressure.

8. The wastewater treatment system of claim 1, wherein each one of the agitating device is a pump, each pump being one of: a centrifugal pump, a homogeneity pump, a spiral pump and a gear pump.

9. The wastewater treatment system of claim 1, wherein the water pipe is installed at one end of the tank and comprises a filter cap, the blow-off pipe being connected to a filter unit which is connected to a pressure filter.

10. The wastewater treatment system of claim 1, wherein the dosing device doses a flocculants, a coagulant and a pH adjuster.
